(19) United States
(12) Patent Application Publication
(10) Pub. No.: US 2014/0317418 A1
(43) Pub. Date: Oct. 23, 2014

(54) SERVER, CLIENT DEVICE, AND USB REDIRECTION METHOD

(71) Applicant: HON HAI PRECISION INDUSTRY CO., LTD., New Taipei (TW)

(72) Inventors: CHIH-YEN LIN, New Taipei (TW); SHAN-CHUAN JENG, New Taipei (TW); CHUNG-I LEE, New Taipei (TW)

(73) Assignee: HON HAI PRECISION INDUSTRY CO., LTD., New Taipei (TW)

(21) Appl. No.: 14/258,002

(22) Filed: Apr. 21, 2014

(30) Foreign Application Priority Data
Apr. 23, 2013 (TW) 102114463

(51) Int. Cl. H04L 29/08; H04L 29/06

(52) U.S. Cl. CPC H04L 67/2814; H04L 63/0471; H04L 67/42
USPC 713/190; 709/203

(57) ABSTRACT

A client device obtains data from a universal serial bus (USB) device and compresses the data. The client device sends the compressed data to a server using a USB redirection. The server decompresses the compressed data and sends the decompressed data to a virtual machine installed in the server. The client device remotely accesses decompressed data when the decompressed data is stored into the virtual machine.

### BACKGROUND

1. Technical Field

Embodiments of the present disclosure relate to data transmitting technology, and particularly to a server, a client device, and a universal serial bus (USB) redirection method.

2. Description of Related Art

A universal serial bus (USB) redirection technology relates to redirecting data from a USB device to a remote server. For example, if the USB device is connected to a client device with a USB redirection function, the client device is capable of redirecting the data to the remote server using the USB redirection. However, if the data is huge, heavy network traffic between the client device and the server may be generated, which may result in network congestion or packet loss. Therefore, there is room for improvement in the art.

### BRIEF DESCRIPTION OF THE DRAWINGS

FIG. 1 is a schematic block diagram of one embodiment of a client device connected to a server.

FIG. 2 is a block diagram of one embodiment of a client device USB redirection system in the client device in FIG. 1.

FIG. 3 is a block diagram of one embodiment of a host USB redirection system in the server in FIG. 1.

FIG. 4 is a flowchart illustrating one embodiment of a USB redirection method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

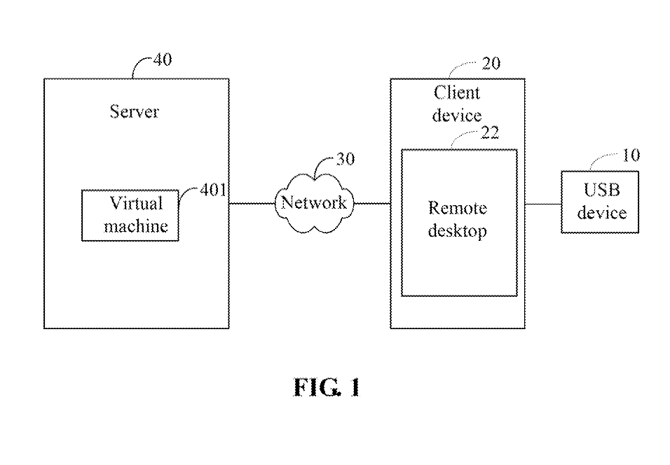

FIG. 1 is a block diagram of one embodiment of a client device 20 connected to a server 40. Depending on the embodiment, the client device 20 is wirelessly connected to the server 40 via a network 30 (e.g., the Internet or a local area network), as shown in FIG. 1. The client device 20 may be, but is not limited to, a personal computer (PC), a tablet computer, a smart mobile phone, a thin client device or any other devices.

The client device 20 can be connected to a universal serial (USB) device 10. The USB device 10 may be, but is not limited to, a USB storage device (e.g., a USB flash drive), a USB camera, a USB token, or any other USB devices. The client device 20 includes a remote desktop 22. The remote desktop 22 may be, but is not limited to, a remote desktop protocol (RDP) application, a virtual desktop infrastructure (VDI) application, or any other remote control applications. The remote desktop 22 can control the client device 20. Furthermore, the remote desktop 22 can remotely access and control the server 40.

The server 40 includes one or more virtual machines 401 (one virtual machine 401 is shown in FIG. 1 for example). The virtual machine 401 stores data acquired from the USB device 10. The data may be, but is not limited to, files, digital certificates, or pictures.

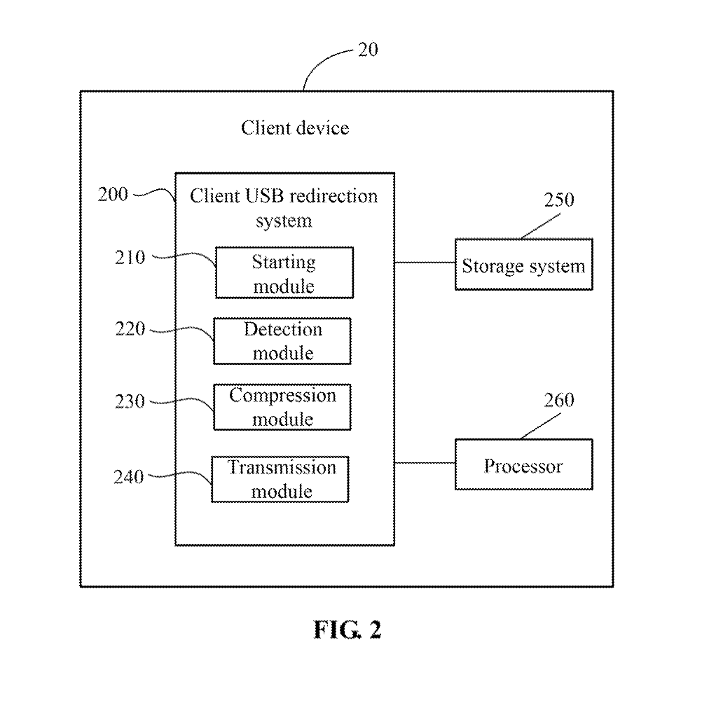

FIG. 2 is a block diagram of one embodiment of a client device USB redirection system 200 in a client device 20. In one embodiment, the client device USB redirection system 200 includes a starting module 210, a detection module 220, a compression module 230, and a transmission module 240. The modules 210-240 may include computerized code in the form of one or more programs that are stored in a storage system 250 of the client device 20. The computerized code includes instructions that are executed by the at least one processor 260 of the client device 20 to provide functions for modules 210-240. The storage system 250 may be a memory chip, a hard disk drive, or a flash memory stick.

The starting module 210 starts a USB redirection in the client device 20 using the remote desktop 22 when the USB device 10 is connected to the client device 20. In one embodiment, if the USB device 10 is plugged in the client device 20, the starting module 210 activates the remote desktop 22 and requests the remote desktop 22 to start the USB redirection in the client device 20.

The detection module 220 detects a type of the USB device 10. In one embodiment, the client 20 includes an operating system (OS), the OS includes a registry which stores one or more values. Each type of the USB device 10 corresponds to one of the one or more values, and a value corresponding to the type of the USB device 10 is determined when the USB device 10 is connected to the client 20. For example, assuming that the USB storage device corresponds to a value A, the value A is determined when the USB storage device is connected to the client 20. The detection module 220 searches for the determined value in the registry and determines the type of the USB device 10 according to the determined value.

The compression module 230 obtains data from the USB device 10 and compresses the data using a compression algorithm corresponding to the type of the USB device 10. The compression algorithm may be, but is not limited to, a Lempel-Ziv-Welch (LZW) algorithm, a Lempel-Ziv-Storer-Szymanski (LZSS) algorithm, a MPEG-1 algorithm, a MPEG-2 algorithm, a MPEG-4 algorithm, a H.254 algorithm, a H.265 algorithm, a LZ77 algorithm or a LZ78 algorithm. In one embodiment, if the USB device 10 is the USB storage device, the compression module 230 compresses the data using the LZW algorithm or the LZSS algorithm. If the USB device 10 is the USB camera device, the compression module 230 compresses the data using the MPEG-1 algorithm, the MPEG-2 algorithm, the MPEG-4 algorithm, the H.254 algorithm, or the H.265 algorithm. If the USB device 10 is the USB token, the compression module 230 compressed the data using the LZ77 algorithm or the LZ78 algorithm. Additionally, the compression module 230 encrypts the compressed data using an encryption algorithm, such as, an advanced encryption standard (AES) algorithm, a data encryption standard (DES) algorithm, or a secure sockets layer (SSL) algorithm.

The transmission module 240 transmits the compressed data to the server 40 using the USB redirection in the client device 20.

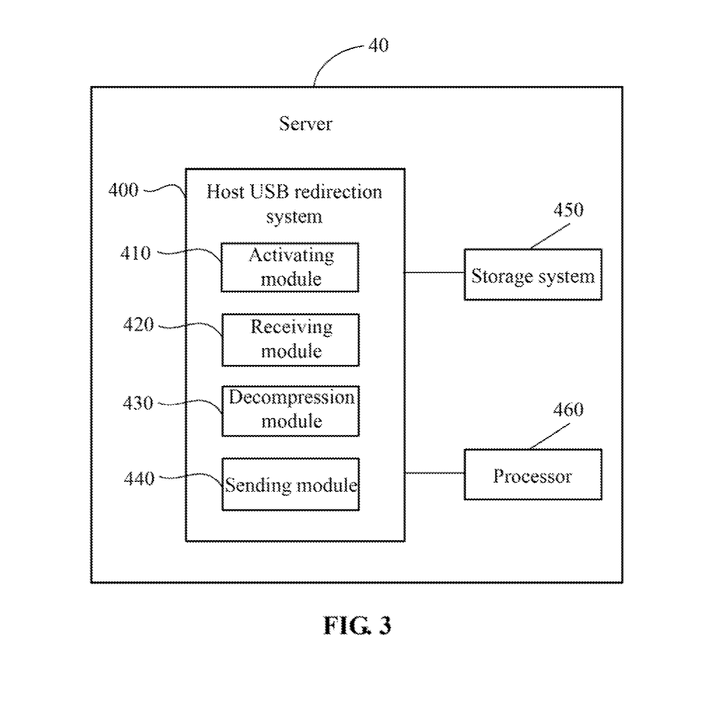

FIG. 3 is a block diagram of one embodiment of a host USB redirection system 400 in a server 40. In one embodiment, the host USB redirection system 400 includes an activating module 410, a receiving module 420, a decompression module 430, and a sending module 440. The modules 410-440 may include computerized code in the form of one or more programs that are stored in a storage system 450 of the server 40. The computerized code includes instructions that are executed by the at least one processor 460 of the server 40 to provide functions for modules 410-440. The storage system 450 may be a memory chip, a hard disk drive, or a flash memory stick.

The activating module 410 activates a USB redirection in the server 40. In one embodiment, the remote desktop 22 sends activating commands to the server 40 when the USB redirection is started in the client device 20, the activating module 410 receives the activating commands and activates the USB redirection in the server 40.

The receiving module 420 receives the compressed data using the USB redirection in the server 40.

The decompression module 430 decompresses the compressed data. In one embodiment, the compressed data includes a filename extension, such as .zip, and .war, for example. The filename extension indicates a file format of the compressed data and the compression algorithm. If the compressed data is compressed by the LZW algorithm, the decompression module 430 determines the filename extension of the compressed data and uses the LZW algorithm to decompress the compressed data. Additionally, if the compressed data is encrypted, the decompression module 430 decrypts the compressed data first, and the decompression module 430 decompresses the compressed data.

The sending module 440 sends the decompressed data to the virtual machine 401. The remote desktop 22 utilized by a user of the client device 20 operates the decompressed data when the decompressed data is stored in the virtual machine 401. For example, the remote desktop 22 utilized by a user of the client device accesses the virtual machine 401 and remotely deletes, edits, or copies the decompressed data.

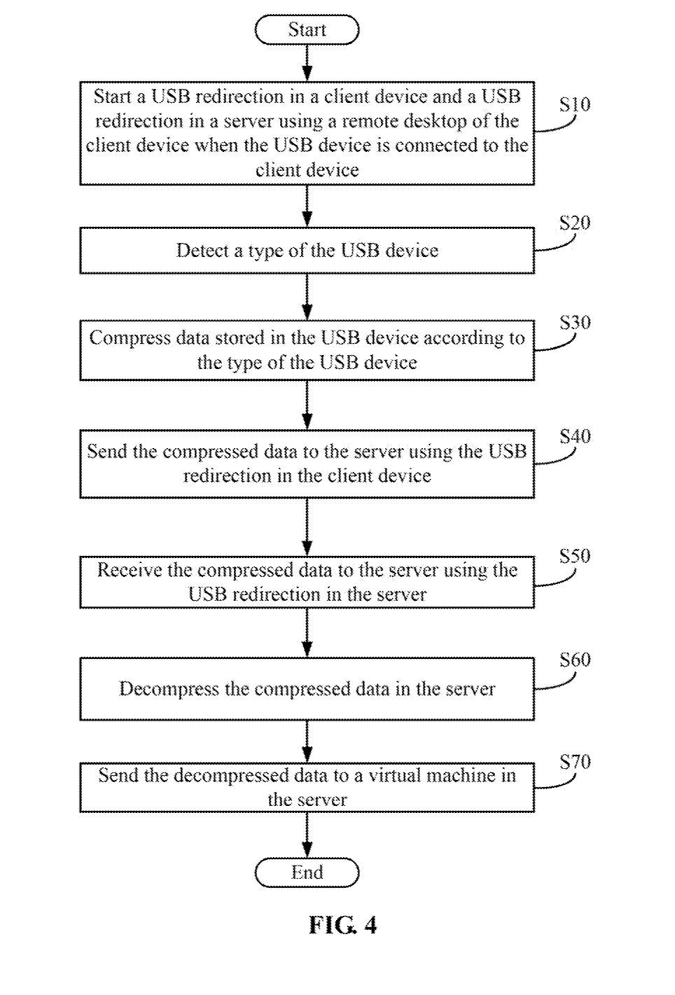

FIG. 4 is a flowchart illustrating one embodiment of a USB redirection method. Depending on the embodiment, additional steps may be added, others deleted, and the ordering of the steps may be changed.

In step S10, the starting module 210 starts a USB redirection in the client device 20 when the USB device 10 is connected to the client device 20, and the activating module 410 activate a USB redirection in the server 40. The USB redirection in the client device 20 is activated by the remote desktop 22 when the USB device 10 is plugged in the client device 20. The remote desktop 22 sends activating commands to the server 40, the activating module 410 activates the USB redirection in the server 40.

In step S20, the detection module 220 detects a type of the USB device 10. The detection module 220 determines the type of the USB device 10 by searching the determined value in the registry of the OS installed in the client device 10.

In step S30, the compression module 230 obtains data from the USB device 10 and compresses the data using a compression algorithm corresponding to the type of the USB device 10. In one embodiment, the LZW algorithm and the LZSS algorithm are used to compress the data from the USB storage device. The MPEG-1 algorithm, the MPEG-2 algorithm, the MPEG-4 algorithm, the H.254 algorithm, and the H.265 algorithm are used to compress the data from the USB camera device. The LZ77 algorithm and the LZ78 algorithm are used to compress the data from the USB token.

In step S40, the transmission module 240 transmits the compressed data to the server 40 using the USB redirection in the client device 20.

In step S50, the receiving module 420 receives the compressed data from the client device 20 using the USB redirection in the server 40.

In step S60, the decompression module 430 decompresses the compressed data. In one embodiment, the decompression module 430 determines the compression algorithm according to the filename extension of the compressed data, and decompress the compressed data using determined compression algorithm.

In step S70, the sending module 440 sends the decompressed data to a virtual machine 401, and the remote desktop 22 remotely operates the decompressed data stored in the virtual machine 401.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A client device in communication with a server, the client device comprising:
a remote desktop;
at least one processor; and
a storage system that stores one or more programs, which when executed by the at least one processor, cause the at least one processor to:
start a universal serial bus (USB) redirection in the client device using the remote desktop when a USB device is connected to the client device;
detect a type of the USB device;
obtain data from the USB device and compress the data using a compression algorithm corresponding to the type of the USB device; and
transmit the compressed data to the server using the USB redirection in the client device.

2. The client device of claim 1, wherein the client device comprises an operating system (OS), the OS comprises a registry which stores one or more values, each type of the USB device corresponds to one value of the one or more values, the value corresponding to the type of the USB device is determined when the USB device is connected to the client device.

3. The client device of claim 2, wherein the type of the USB device is determined by searching the determined value corresponding to the USB device in the registry of the OS in the client.

4. The client device of claim 1, wherein the compression algorithm is selected from a group which comprises a LZW algorithm, a LZSS algorithm, a MPEG-1 algorithm, a MPEG-2 algorithm, a MPEG-4 algorithm, a H.254 algorithm, a H.265 algorithm, a LZ77 algorithm and a LZ78 algorithm.

5. The client device of claim 1, the compressed data is encrypted by an encryption algorithm.

6. A server in communication to a client device, the server comprising:
a virtual machine
at least one processor; and
a storage system that stores one or more programs, which when executed by the at least one processor, cause the at least one processor to:
activate a universal serial bus (USB) redirection in the server;
receive compressed data from the client device using the USB redirection in the server;
decompress the compressed data; and
send the decompressed data to the virtual machine, the decompressed data in the virtual machine being operated remotely through a remote desktop of the client device.

7. The server of claim 6, wherein the USB redirection is activated in the server when the remote desktop of the client device sends the activating commands to the server.

8. The server of claim 6, wherein the compressed data comprises a filename extension which indicates a file format of the compressed data and a compression algorithm.

9. The server of claim 8, wherein the compression algorithm is determined according to the filename extension of the compressed data, and the compressed data is decompressed using the determined compression algorithm.

10. The server of claim 8, wherein the compression data is decrypted by an encryption algorithm.

11. A USB redirection method between a client device and a server, the USB redirection method comprising:
starting a universal serial bus (USB) redirection in the client device using the remote desktop when a USB device is connected to the client device;
detecting a type of the USB device;
obtaining data from the USB device and compress the data using a compression algorithm corresponding to the type of the USB device;
transmitting the compressed data to the server using the USB redirection in the client device;
activating a USB redirection in the server;
receiving the compressed data from the client device using the USB redirection in the server;
decompressing the compressed data; and
sending the decompressed data to the virtual machine, the decompressed data in the virtual machine being operated remotely through a remote desktop of the client device.

12. The USB redirection method of claim 11, wherein the client device comprises an operating system (OS), the OS comprises a registry which stores one or more values, each type of the USB device corresponds to one value of the one or more values, the value corresponding to the type of the USB device is determined when the USB device is connected to the client device.

13. The USB redirection method of claim 12, wherein the type of the USB device is determined by searching the determined value corresponding to the USB device in the registry of the OS in the client.

14. The USB redirection method of claim 11, wherein the compression algorithm is selected from a group which comprises a LZW algorithm, a LZSS algorithm, a MPEG-1 algorithm, a MPEG-2 algorithm, a MPEG-4 algorithm, a H.254 algorithm, a H.265 algorithm, a LZ77 algorithm and a LZ78 algorithm.

15. The USB redirection method of claim 11, wherein the USB redirection is activated in the server when the remote desktop of the client device sends the activating commands to the server.

16. The USB redirection method of claim 11, wherein the compressed data comprises a filename extension which indicates a file format of the compressed data and a compression algorithm.

17. The USB redirection method of claim 16, wherein the compression algorithm is determined according to the filename extension of the compressed data, and the compressed data is decompressed using the determined compression algorithm.
